(19) United States
(12) Patent Application Publication
(10) Pub. No.: US 2021/0124378 A1
(43) Pub. Date: Apr. 29, 2021

(54) COOLING BASED ON HARDWARE ACTIVITY PATTERNS

(71) Applicant: LENOVO ENTERPRISE SOLUTIONS (SINGAPORE) PTE. LTD., SINGAPORE (SG)

(72) Inventors: LUKE D. REMIS, RALEIGH, NC (US); JASON A. MATTESON, RALEIGH, NC (US); GARY D. CUDAK, WAKE FOREST, NC (US); APARNA VALLURY, APEX, NC (US)

(21) Appl. No.: 16/661,521

(22) Filed: Oct. 23, 2019

(51) Int. Cl. G05D 23/19; G05B 13/02

(52) U.S. Cl. CPC G05D 23/1917; G05B 13/0265

(57) ABSTRACT

Cooling based on hardware activity patterns, including: identifying a hardware activity pattern associated with a system; determining, based on the hardware activity pattern, one or more cooling actions; and applying the one or more cooling actions to the system.

### BACKGROUND

### Field of the Invention

The field of the invention is data processing, or, more specifically, methods, apparatus, and products for cooling based on hardware activity patterns.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

### SUMMARY

Cooling based on hardware activity patterns, including: identifying a hardware activity pattern associated with a system; determining, based on the hardware activity pattern, one or more cooling actions; and applying the one or more cooling actions to the system.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of an example system for cooling based on hardware activity patterns according to embodiments of the present invention.

FIG. 2 is a block diagram of an example computing device for cooling based on hardware activity patterns according to embodiments of the present invention.

FIG. 3 is a flowchart of an example method for cooling based on hardware activity patterns according to embodiments of the present invention.

FIG. 4 is a flowchart of an example method for cooling based on hardware activity patterns according to embodiments of the present invention.

FIG. 5 is a flowchart of an example method for cooling based on hardware activity patterns according to embodiments of the present invention.

FIG. 6 is a flowchart of an example method for cooling based on hardware activity patterns according to embodiments of the present invention.

FIG. 7 is a flowchart of an example method for cooling based on hardware activity patterns according to embodiments of the present invention.

FIG. 8 is a flowchart of an example method for cooling based on hardware activity patterns according to embodiments of the present invention.

FIG. 9 is a flowchart of an example method for cooling based on hardware activity patterns according to embodiments of the present invention.

### DETAILED DESCRIPTION

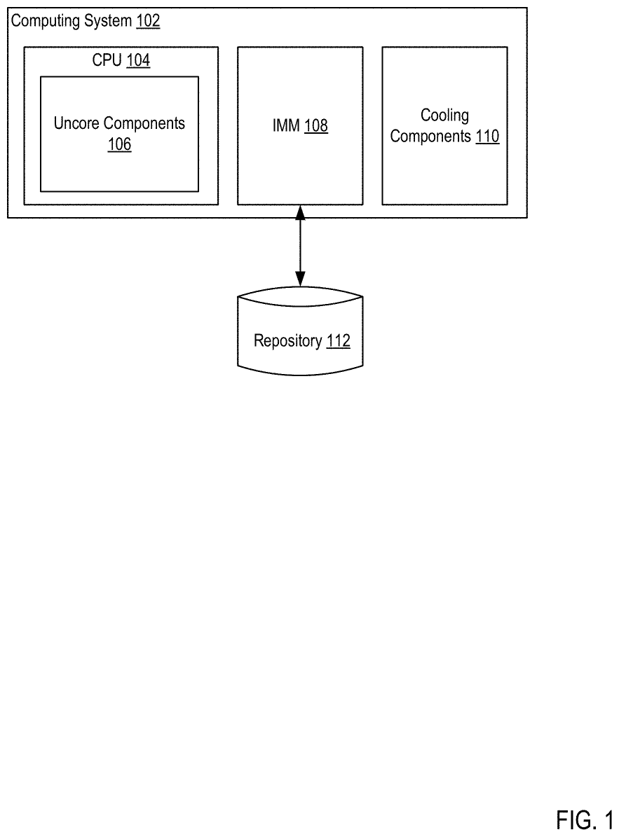

Exemplary methods, apparatus, and products for cooling based on hardware activity patterns in accordance with the present invention are described with reference to the accompanying drawings, beginning with FIG. 1. FIG. 1 sets forth a block diagram of a system configured for cooling based on hardware activity patterns according to embodiments of the present invention. The system of FIG. 1 includes a computing system 102 that includes a central processing unit (CPU) 104. The CPU 104 includes one or more uncore components 106. Uncore components 106 comprise functional components of the CPU 104 that are not directly part of the core, but assist in functions of the core. Examples of uncore components 106 may include L3 cache, QuickPath Interconnect (QPI) controllers, a snoop agent pipeline, on-die memory controllers, and other components.

The computing system 102 may also include an integrated management module (IMM) 108, a chip configured to perform cooling based on hardware activity patterns. Although the operations herein are described as being performed by the IMM 108, it is understood that the functionality of the IMM 108 may instead be performed by an agent on the CPU 104, or by another module or component.

The computing system 102 also includes one or more cooling components 110 configured to apply a cooling action to components of the computing system 102. For example, the cooling components 110 may include fans, water cooling pumps, or other active components that facilitate cooling components of the computing system 102.

Existing cooling solutions require temperature measurements of the computing system 102 to be taken. When the temperature measurement exceeds a threshold, one or more cooling components 110 may be activated to cool the components of the computing system 102. Where the temperature threshold is too high, a large amount of power may be required to cool the computing system 102 to a safe temperature (e.g., below the temperature threshold). Where the temperature threshold is too low, cooling may be initiated at times when the computing system 102 is not at risk for approaching an unsafe temperature, potentially wasting power used for cooling.

Instead of using these approaches where cooling is based on a temperature threshold, the IMM 108 may identify a hardware activity pattern associated with the computing system 102. The hardware activity pattern may comprise an activity pattern of signals in the CPU 104. For example, the hardware activity pattern may comprise an intensity of a signal, a direction of a signal, one or more components through which a signal travels, or other attributes of signals in the CPU 104. The signals may be associated with uncore components 106 or other components of the CPU 104 (e.g., buses). The hardware activity pattern may also comprise a frequency of component use or access (e.g., a frequency of component use or access for uncore components 106 or other components of the CPU 104). In other words, the hardware activity pattern may be based on one or more buses, one or more uncore components 106, or other components of the CPU 104.

Accordingly, the IMM 108 may maintain one or more counters associated with the one or more uncore components 106. A counter may increment each time an uncore component 106 is accessed, used, or otherwise interacted with. Counter readings may then be provided directly to the IMM 108, or sent side-band to the IMM 108 (e.g., using Inter-integrated circuit (I2C)). Accordingly, identifying the hardware activity pattern may comprise identifying, based on the one or more counters, the hardware activity pattern. For example, the counter readings may then be used to determine a frequency of use or access of a corresponding uncore component 106.

Signal information (e.g., information indicating the direction of a signal, the intensity of a signal, one or more components through which a signal is passing) may also be sent directly to the IMM 108. For example, the IMM 108 may tap or access one or more buses, traces, etc. of the CPU 104 to measure the signal information. The signal information may also be sent to the IMM 108 side band using I2C or another approach.

The IMM 108 may then determine, based on the hardware activity pattern, one or more cooling actions. The cooling actions may comprise a particular cooling component 110 to be activated (e.g., a particular fan), an intensity of a cooling action to be applied (e.g., a fan speed), or other attributes. Determining, based on the hardware activity pattern, one or more cooling actions may comprise determining, based on a cooling table, the one or more cooling actions.

A cooling table may comprise a plurality of entries. Each entry in the cooling table may list a hardware activity pattern (e.g., a particular frequency of use of a component, a particular signal intensity or direction with respect to a particular component, etc., and combinations thereof) and one or more corresponding cooling actions to be applied when the hardware activity pattern is detected. For example, assume that the IMM 108 has identified a hardware activity pattern comprising a particular uncore component 106 usage frequency (e.g., based on a corresponding counter) and a particular signal direction and intensity in the CPU 104. The IMM 108 may then identify a cooling table entry matching the detected hardware activity pattern and determine, based on the cooling table entry, the one or more cooling actions (e.g., which fans to activate at which speeds).

As another example, assume that the IMM 108 has identified signal activity of a bus connected to a Graphics Processing Unit (GPU) indicating that GPU activity is increasing (e.g., high signal intensity, high frequency of bus access or use). The IMM 108 may then identify a cooling table entry corresponding to the detected hardware activity pattern (e.g., the signal activity). The cooling table entry may comprise cooling actions comprising activation of a fan directed toward the GPU, thereby cooling the GPU.

The IMM 108 may then apply the one or more cooling actions to the computing system 102. For example, the IMM 108 may activate one or more cooling components 110 according to the determined cooling actions (e.g., at what speed, for how long, until what condition is satisfied).

After applying the one or more cooling actions, the IMM 108 may measure one or more cooling characteristics of the one or more cooling actions. The cooling characteristics indicate an effect on the temperature of the computing system 102 or components thereof by the application of the cooling actions. For example, the cooling characteristics may indicate a rate of change in temperature, a time taken to reach a target temperature, or other characteristics. Accordingly, the cooling characteristics are indicative of an effectiveness of a particular cooling action on cooling the computing system 102.

The IMM 108 may then update, based on the one or more cooling characteristics and a machine learning model, one or more parameters of the cooling table. The machine learning model may serve to evaluate or rate the applied cooling actions based on the measured cooling characteristics. For example, the machine learning model may encode one or more target cooling characteristics (e.g., a target time to reach a particular temperature, a target rate of cooling for a particular component, etc.) and apply a score to the one or more cooling actions based on the measured cooling characteristics. For example, a lower score may be given to a cooling action that took longer than a target time to reach a target temperature, while a higher score may be given to a cooling action whose time to reach a target temperature was closer to the target time. A lower score may also be given when a cooling action reaches the target temperature in a time shorter than the target time.

Updating the one or more parameters of the cooling table may include updating an intensity or power of a cooling component 110 used in a particular cooling action. For example, assume that the machine learning model produces a lower rating (e.g., lower than a threshold) due to a measured time to reach a target temperature being longer than a target time. The cooling table may be updated to increase a power of a fan used in the cooling action. Updating the one or more parameters of the cooling table may include adding additional cooling components 110 for use in a particular cooling action.

As another example, assume that the machine learning model produces a lower rating (e.g., lower than a threshold) due to a measured time to reach a target temperature being shorter than a target time. The cooling table may be updated to decrease a power of a fan used in the cooling action. Thus, power usage in cooling actions may be optimized in order to reach targeted goals.

The IMM 108 may determine to make the cooling table immutable. In other words, entries of the cooling table may be restricted from future modification. The IMM 108 may make the entirety of the cooling table immutable, or a particular entry of the cooling table immutable. For example, assume that the IMM 108 measures cooling characteristics that rate highly (e.g., above a threshold) as determined by the machine learning model. Assume that these high ratings occur for a predetermined amount of time, across a predetermined amount of measurements, etc., indicating that the cooling actions of the cooling table are optimized. The IMM 108 may then determine to make the cooling table immutable (e.g., all of the cooling table or a particular entry). Thus, the IMM 108 need not take future cooling characteristic measurements for the particular cooling table or entry and save on the computational burden in evaluating the performance of future cooling actions.

The IMM 108 may determine to make a particular entry of the cooling table immutable. For example, assume that highly rated cooling characteristics are measured for cooling actions of a particular entry in the cooling table. That entry of the cooling table may be made immutable, while other entries of the cooling table may be subsequently modified until they reach an optimized state.

The cooling table may correspond to a state for the computing system 102. For example, the cooling table may correspond to a particular hardware configuration for the computing system 102 and loaded into the computing system 102 at manufacture or configuration time. As another example, the IMM 108 may determine a system state for the computing system 102. The system state may comprise a particular hardware configuration for the computing system 102 (e.g., what hardware components are included in the computing system 102, identification of slots or locations of the hardware components in the computing system 102, etc.). The system state may also comprise currently running services, applications, etc.

The IMM 108 may then load the cooling table based on the system state. The cooling table may be loaded from local memory of the computing system 102 (e.g., a data structure storing cooling tables in association with system states). The cooling table may be loaded from a repository 112. The repository 112 may be locally stored in the computing system 102. The repository 112 may be implemented on another computing device or server on the same network as the computing system 102. The repository 112 may also be remotely disposed from the computing system 102. Accordingly, the IMM 108 may query the repository 112 with the system state. The IMM 108 may then receive, in response to the system state, a cooling table. The cooling table may then be loaded and used for cooling based on hardware activity patterns.

As was set forth above, the cooling table may be updated based on a machine learning model and measured cooling characteristics. The IMM 108 may send the updated cooling table to a repository 112. For example, the IMM 108 may send the updated cooling table to the repository 112 with the system state. Thus, the repository 112 can store an updated cooling table in association with the system state for subsequent loading by the computing system 102 or other computing systems 102 with matching system states. The IMM 108 may send the cooling table to the repository 112 in response to determining to make the cooling table, or one or more entries in the cooling table, immutable. The repository 112 may be configured to aggregate one or more immutable portions of submitted cooling tables into a new cooling table comprising optimized cooling table entries received from various computing systems 102.

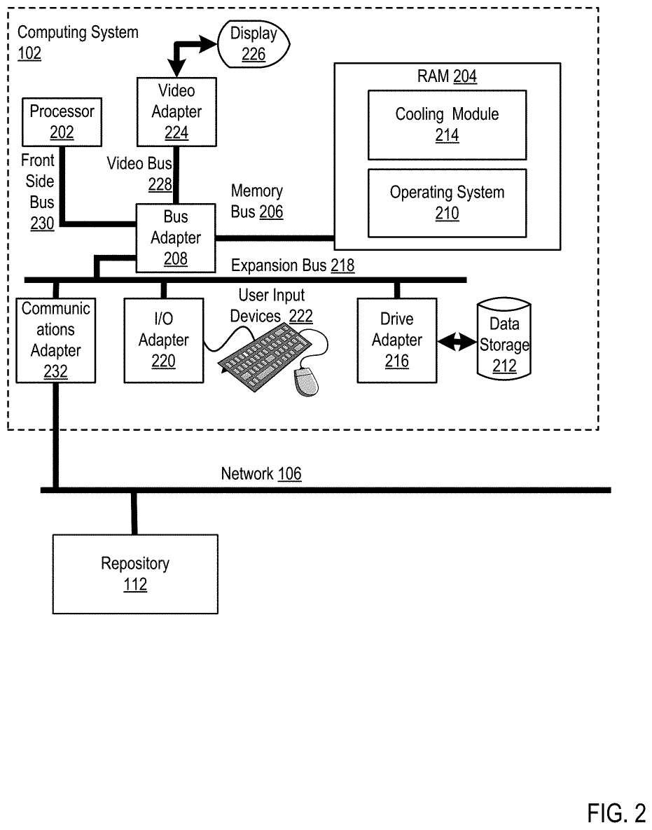

Cooling based on hardware activity patterns in accordance with the present invention is generally implemented with computers, that is, with automated computing machinery. For further explanation, therefore, FIG. 2 sets forth a block diagram of automated computing machinery comprising an exemplary computing system 102 configured for cooling based on hardware activity patterns according to embodiments of the present invention. The computing system 102 of FIG. 2 includes at least one computer processor 202 or ‘CPU’ as well as random access memory 204 (RAM′) which is connected through a high speed memory bus 206 and bus adapter 208 to processor 202 and to other components of the computing system 102.

Stored in RAM 204 is an operating system 210. Operating systems useful in computers configured for cooling based on hardware activity patterns according to embodiments of the present invention include UNIX™, Linux™, Microsoft Windows™, AIX™, IBM's i OS™, and others as will occur to those of skill in the art. The operating system 208 in the example of FIG. 2 is shown in RAM 204, but many components of such software typically are stored in non-volatile memory also, such as, for example, on data storage 212, such as a disk drive. Also stored in RAM is the cooling module 214 a module for cooling based on hardware activity patterns according to embodiments of the present invention.

The computing system 102 of FIG. 2 includes disk drive adapter 216 coupled through expansion bus 218 and bus adapter 208 to processor 202 and other components of the computing system 102. Disk drive adapter 216 connects non-volatile data storage to the computing system 102 in the form of data storage 212. Disk drive adapters useful in computers configured for cooling based on hardware activity patterns according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 102 of FIG. 2 includes one or more input/output (′I/O′) adapters 220. I/O adapters implement user-oriented input/output through, for example, software drivers and computer hardware for controlling output to display devices such as computer display screens, as well as user input from user input devices 222 such as keyboards and mice. The example computing system 102 of FIG. 2 includes a video adapter 224, which is an example of an I/O adapter specially designed for graphic output to a display device 226 such as a display screen or computer monitor. Video adapter 224 is connected to processor 202 through a high speed video bus 228, bus adapter 208, and the front side bus 230, which is also a high speed bus.

The exemplary computing system 102 of FIG. 2 includes a communications adapter 232 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for cooling based on hardware activity patterns according to embodiments of the present invention include modems for wired dial-up communications, Ethernet (IEEE 802.3) adapters for wired data communications, and 802.11 adapters for wireless data communications.

The communications adapter 232 is communicatively coupled to a network 106 that also includes a repository 112.

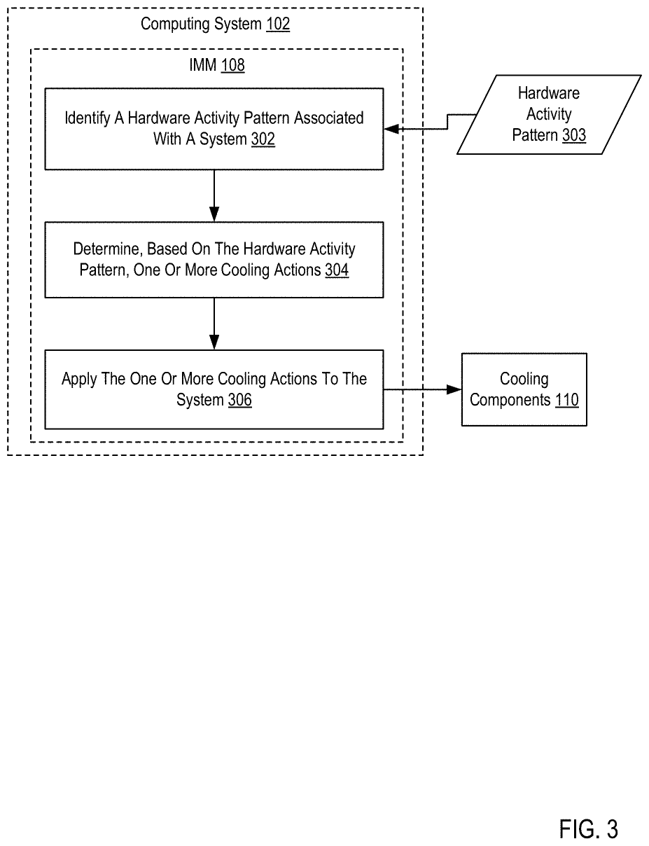

For further explanation, FIG. 3 sets forth a flow chart illustrating an exemplary method for cooling based on hardware activity patterns according to embodiments of the present invention that includes identifying 302 (e.g., by an IMM 108) a hardware activity pattern 303 associated with a system (e.g., a computing system 102). The hardware activity pattern 303 may comprise an activity pattern of signals in the CPU 104. For example, the hardware activity pattern 303 may comprise an intensity of a signal, a direction of a signal, one or more components through which a signal travels, or other attributes of signals in the CPU 104. The signals may be associated with uncore components 106 or other components of the CPU 104 (e.g., buses, traces, etc.). The hardware activity pattern 303 may also comprise a frequency of component use or access (e.g., a frequency of component use or access for uncore components 106 or other components of the CPU 104). In other words, the hardware activity pattern 303 may be based on one or more buses, one or more uncore components 106, or other components of the CPU 104.

Signal information (e.g., information indicating the direction of a signal, the intensity of a signal, one or more components through which a signal is passing) may also be sent directly to the IMM 108. For example, the IMM 108 may tap or access one or more buses, traces, etc. of the CPU 104 to measure the signal information. The signal information may also be sent to the IMM 108 side band using I2C or another approach.

The method of FIG. 3 also includes determining 304 (e.g., by the IMM 108), based on the hardware activity pattern 303, one or more cooling actions. The cooling actions may comprise a particular cooling component 110 to be activated (e.g., a particular fan), an intensity of a cooling action to be applied (e.g., a fan speed), or other attributes. As an example, assume that the IMM 108 has identified, as a hardware activity pattern 303, increased signal activity of a bus connected to a Graphics Processing Unit (GPU) indicating that GPU activity is increasing (e.g., increased signal intensity, increased frequency of bus access or use). The IMM 108 may then determine cooling actions comprising activation of a fan directed toward the GPU, thereby cooling the GPU.

Determining 304, based on the hardware activity pattern 303, one or more cooling actions may comprise determining, based on a cooling table, the one or more cooling actions. A cooling table may comprise a plurality of entries. Each entry in the cooling table may list a hardware activity pattern (e.g., a particular frequency of use of a component, a particular signal intensity or direction with respect to a particular component, etc., and combinations thereof) and one or more corresponding cooling actions to be applied when the hardware activity pattern is detected. For example, assume that the IMM 108 has identified a hardware activity pattern comprising a particular uncore component 106 usage frequency (e.g., based on a corresponding counter) and a particular signal direction and intensity in the CPU 104. The IMM 108 may then identify a cooling table entry matching the detected hardware activity pattern and determine, based on the cooling table entry, the one or more cooling actions (e.g., which fans to activate at which speeds).

The method of FIG. 3 also includes applying 306 (e.g., by the IMM 108) the one or more cooling actions to the system (e.g., the computing system 102). For example, the IMM 108 may activate one or more cooling components 110 according to the determined cooling actions (e.g., at what speed, for how long, until what condition is satisfied).

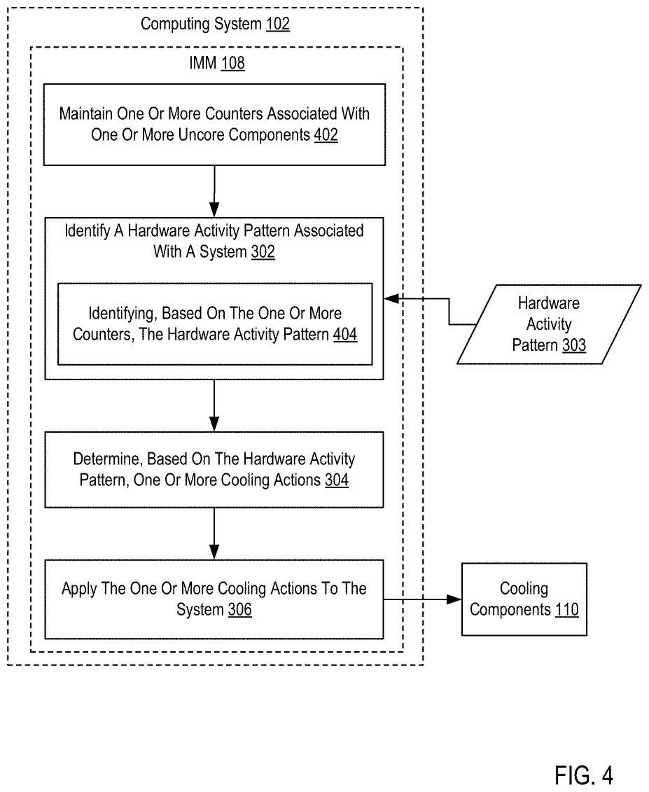

For further explanation, FIG. 4 sets forth a flow chart illustrating an exemplary method for cooling based on hardware activity patterns according to embodiments of the present invention that includes identifying 302 (e.g., by an IMM 108) a hardware activity pattern 303 associated with a system (e.g., a computing system 102); determining 304 (e.g., by the IMM 108), based on the hardware activity pattern 303, one or more cooling actions; and applying 306 (e.g., by the IMM 108), the one or more cooling actions to the system.

The method of FIG. 4 differs from FIG. 3 in that the method of FIG. 4 also includes maintaining 402 (e.g., by the IMM 108) one or more counters associated with the one or more uncore components 106. A counter may increment each time an uncore component 106 is accessed, used, or otherwise interacted with. Counter readings may then be provided directly to the IMM 108, or sent side-band to the IMM 108 (e.g., using Inter-integrated circuit (I2C), or by another side-band approach).

The method of FIG. 4 further differs from FIG. 3 in that identifying 302 the hardware activity pattern 303 comprises identifying 404, based on the one or more counters, the hardware activity pattern 303. For example, identifying 404, based on the one or more counters, the hardware activity pattern 303 may comprise identifying one or more counter frequencies, one or more counter readings, etc.

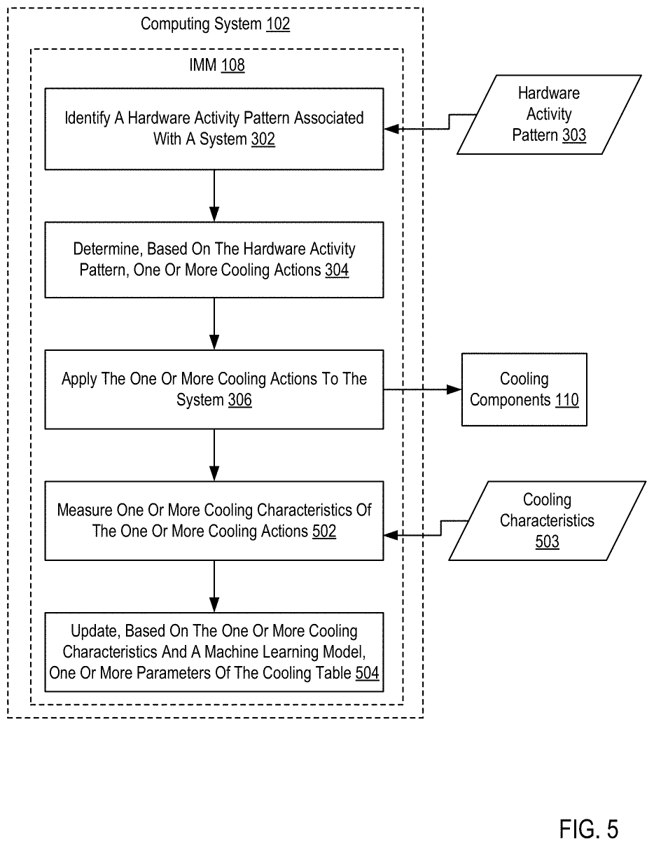

For further explanation, FIG. 5 sets forth a flow chart illustrating an exemplary method for cooling based on hardware activity patterns according to embodiments of the present invention that includes identifying 302 (e.g., by an IMM 108) a hardware activity pattern 303 associated with a system (e.g., a computing system 102); determining 304 (e.g., by the IMM 108), based on the hardware activity pattern 303, one or more cooling actions; and applying 306 (e.g., by the IMM 108), the one or more cooling actions to the system.

The method of FIG. 5 differs from FIG. 3 in that the method of FIG. 5 also includes measuring 502 (e.g., by the IMM 108) one or more cooling characteristics 503 of the one or more cooling actions. The cooling characteristics 503 indicate an effect on the temperature of the computing system 102 or components thereof by the application of the cooling actions. For example, the cooling characteristics 503 may indicate a rate of change in temperature, a time taken to reach a target temperature, or other characteristics. Accordingly, the cooling characteristics 503 are indicative of an effectiveness of a particular cooling action on cooling the computing system 102.

The method of FIG. 5 differs from FIG. 3 in that the method of FIG. 5 also includes updating 504 (e.g., by the IMM 108), based on the one or more cooling characteristics 503 and a machine learning model, one or more parameters of the cooling table. The machine learning model may serve to evaluate or rate the applied cooling actions based on the measured cooling characteristics 503. For example, the machine learning model may encode one or more target cooling characteristics 503 (e.g., a target time to reach a particular temperature, a target rate of cooling for a particular component, etc.) and apply a score to the one or more cooling actions based on the measured cooling characteristics 503. For example, a lower score may be given to a cooling action that took longer than a target time to reach a target temperature, while a higher score may be given to a cooling action whose time to reach a target temperature was closer to the target time. A lower score may also be given when a cooling action reaches the target temperature in a time shorter than the target time.

Updating 504 the one or more parameters of the cooling table may include updating an intensity or power of a cooling component 110 used in a particular cooling action. For example, assume that the machine learning model produces a lower rating (e.g., lower than a threshold) due to a measured time to reach a target temperature being longer than a target time. The cooling table may be updated to increase a power of a fan used in the cooling action. Updating the one or more parameters of the cooling table may include adding additional cooling components 110 for use in a particular cooling action.

As another example, assume that the machine learning model produces a lower rating (e.g., lower than a threshold) due to a measured time to reach a target temperature being shorter than a target time. The cooling table may be updated to decrease a power of a fan used in the cooling action. Thus, power usage in cooling actions may be optimized in order to reach targeted goals.

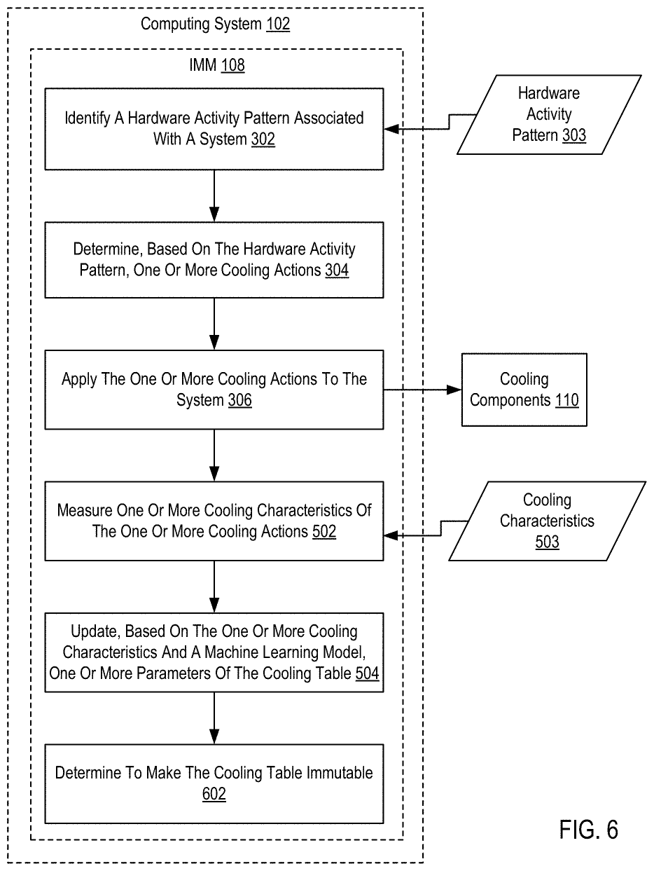

For further explanation, FIG. 6 sets forth a flow chart illustrating an exemplary method for cooling based on hardware activity patterns according to embodiments of the present invention that includes identifying 302 (e.g., by an IMM 108) a hardware activity pattern 303 associated with a system (e.g., a computing system 102); determining 304 (e.g., by the IMM 108), based on the hardware activity pattern 303, one or more cooling actions; applying 306 (e.g., by the IMM 108), the one or more cooling actions to the system; measuring 502 one or more cooling characteristics 503 of the one or more cooling actions; and updating 504, based on the one or more cooling characteristics and a machine learning model, one or more characteristics of the cooling table.

The method of FIG. 6 differs from FIG. 5 in that the method of FIG. 5 also includes determining 602 to make the cooling table immutable. In other words, entries of the cooling table may be restricted from future modification. The IMM 108 may make the entirety of the cooling table immutable, or a particular entry of the cooling table immutable. For example, assume that the IMM 108 measures cooling characteristics that rate highly (e.g., above a threshold) as determined by the machine learning model. Assume that these high ratings occur for a predetermined amount of time, across a predetermined amount of measurements, etc., indicating that the cooling actions of the cooling table are optimized. The IMM 108 may then determine to make the cooling table immutable (e.g., all of the cooling table or a particular entry). Thus, the IMM 108 need not take future cooling characteristic measurements for the particular cooling table or entry and save on the computational burden in evaluating the performance of future cooling actions.

The IMM 108 may determine to make a particular entry of the cooling table immutable. For example, assume that highly rated cooling characteristics are measured for cooling actions of a particular entry in the cooling table. That entry of the cooling table may be made immutable, while other entries of the cooling table may be subsequently modified until they reach an optimized state.

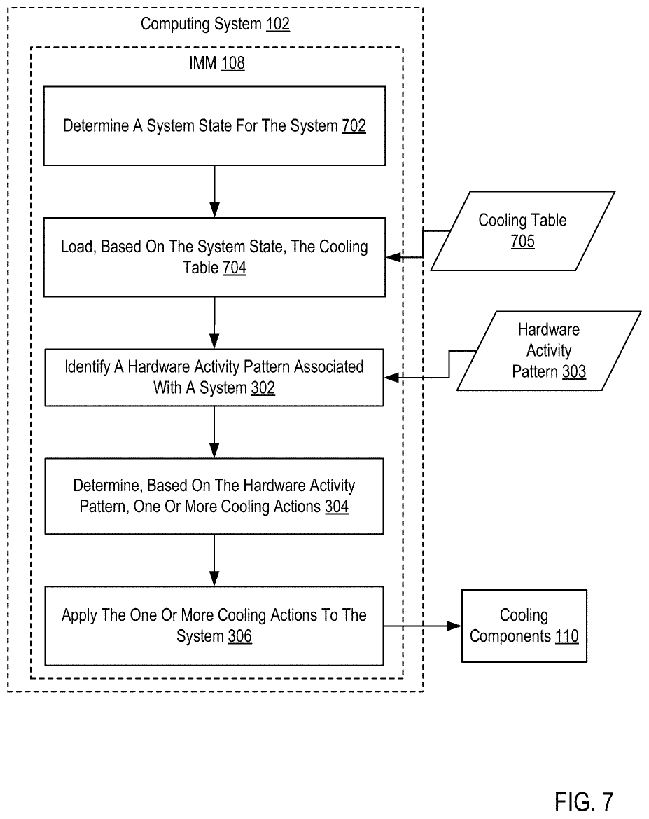

For further explanation, FIG. 7 sets forth a flow chart illustrating an exemplary method for cooling based on hardware activity patterns according to embodiments of the present invention that includes identifying 302 (e.g., by an IMM 108) a hardware activity pattern 303 associated with a system (e.g., a computing system 102); determining 304 (e.g., by the IMM 108), based on the hardware activity pattern 303, one or more cooling actions; and applying 306 (e.g., by the IMM 108), the one or more cooling actions to the system.

The method of FIG. 7 differs from FIG. 3 in that the method of FIG. 7 also includes determining 702 (e.g., by the IMM 108) a system state for the computing system 102. The system state may comprise a particular hardware configuration for the computing system 102 (e.g., what hardware components are included in the computing system 102, identification of slots or locations of the hardware components in the computing system 102, etc.). The system state may also comprise currently running services, applications, etc.

The method of FIG. 7 also includes loading 704 (e.g., by the IMM 108) the cooling table 705 based on the system state. The cooling table may be loaded from local memory of the computing system 102 (e.g., a data structure storing cooling tables in association with system states). The cooling table may also be loaded from a repository 112.

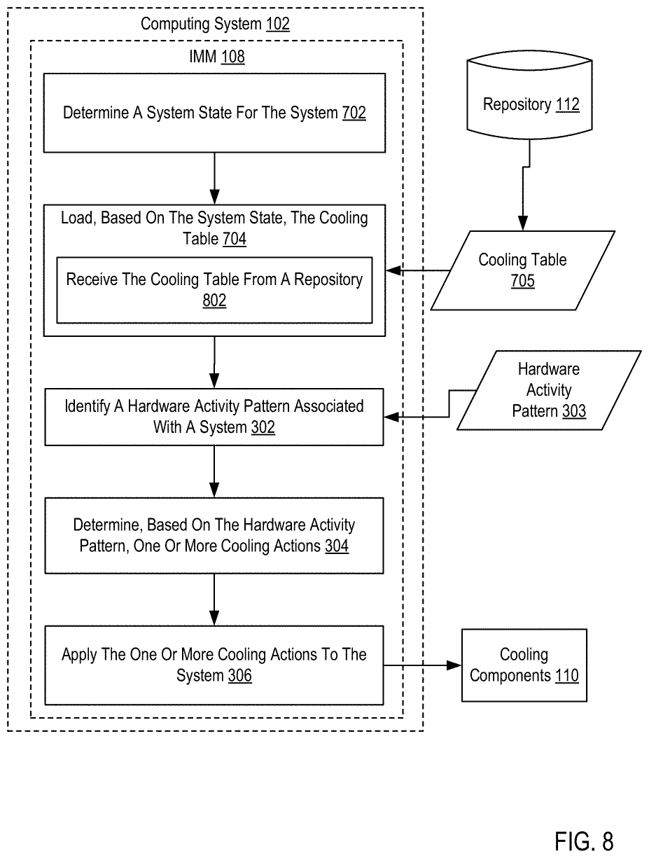

For further explanation, FIG. 8 sets forth a flow chart illustrating an exemplary method for cooling based on hardware activity patterns according to embodiments of the present invention that includes determining 702 (e.g., by the IMM 108) a system state for the system; loading 704 (e.g., by the IMM 108), based on the system state, the cooling table 705; identifying 302 (e.g., by an IMM 108) a hardware activity pattern 303 associated with a system (e.g., a computing system 102); determining 304 (e.g., by the IMM 108), based on the hardware activity pattern 303, one or more cooling actions; and applying 306 (e.g., by the IMM 108), the one or more cooling actions to the system.

The method of FIG. 8 differs from FIG. 7 in that loading 704, based on the system state, the cooling table 705 comprises receiving 802 (e.g., by the IMM 108) the cooling table from a repository 112. The repository 112 may comprise a data store, database, or other system configured to store cooling tables 705 in association with system states. The repository 112 may be locally stored and implemented in the computing system 102. The repository 112 may be implemented on another computing device or server on the same network as the computing system 102. The repository 112 may also be remotely disposed from the computing system 102. Accordingly, the IMM 108 may query the repository 112 with the system state. The IMM 108 may then receive, in response to the system state, a cooling table 705.

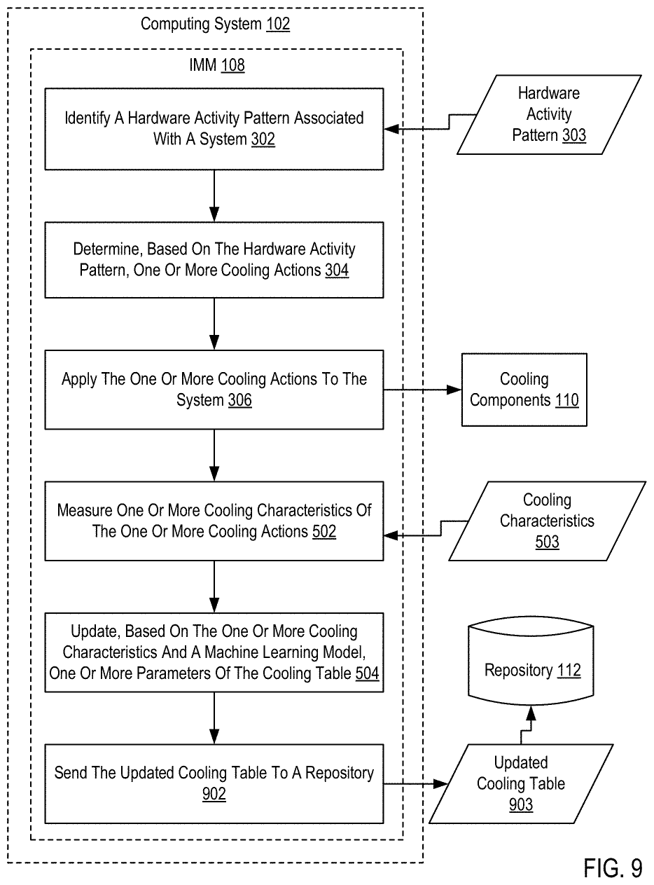

For further explanation, FIG. 9 sets forth a flow chart illustrating an exemplary method for cooling based on hardware activity patterns according to embodiments of the present invention that includes identifying 302 (e.g., by an IMM 108) a hardware activity pattern 303 associated with a system (e.g., a computing system 102); determining 304 (e.g., by the IMM 108), based on the hardware activity pattern 303, one or more cooling actions; applying 306 (e.g., by the IMM 108), the one or more cooling actions to the system; measuring 502 one or more cooling characteristics 503 of the one or more cooling actions; and updating 504, based on the one or more cooling characteristics and a machine learning model, one or more characteristics of the cooling table.

The method of FIG. 9 differs from FIG. 5 in that the method of FIG. 9 also includes sending 902 (e.g., by the IMM 108) the updated cooling table 903 to a repository 112. For example, the IMM 108 may send the updated cooling table 903 to the repository 112 with the system state. Thus, the repository 112 can store an updated cooling table 903 in association with the system state for subsequent loading by the computing system 102 or other computing systems 102 with matching system states. The IMM 108 may send 902 the updated cooling table 903 to the repository 112 in response to determining to make the updated cooling table 903, or one or more entries in the updated cooling table 903, immutable.

In view of the explanations set forth above, readers will recognize that the benefits of cooling based on hardware activity patterns according to embodiments of the present invention include:
Improved performance of a computing system by providing for cooling activity proactively based on hardware activity patterns, instead of reactively based on temperature readings, thereby saving on overall power consumption.
Improved performance of a computing system by allowing for cooling tables to be updated based on performance ratings and cooling targets, allowing for optimized cooling tables.
Improved performance of a computing system by associating system states with cooling tables, providing for optimized cooling tables to be reused across computing systems with similar configurations.

Exemplary embodiments of the present invention are described largely in the context of a fully functional computer system for cooling based on hardware activity patterns. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method, comprising:
identifying a hardware activity pattern associated with a system;
determining, based on the hardware activity pattern, one or more cooling actions; and
applying the one or more cooling actions to the system.

2. The method of claim 1, wherein the hardware activity pattern is based on one or more uncore components.

3. The method of claim 2, further comprising:
maintaining one or more counters associated with the one or more uncore components; and
wherein identifying the hardware activity pattern comprises identifying, based on the one or more counters, the hardware activity pattern.

4. The method of claim 1, wherein determining the one or more cooling actions comprises determining, based on a cooling table, the one or more cooling actions.

5. The method of claim 4, further comprising:
measuring one or more cooling characteristics of the one or more cooling actions; and
updating, based on the one or more cooling characteristics and a machine learning model, one or more parameters of the cooling table.

6. The method of claim 5, further comprising determining to make the cooling table immutable.

7. The method of claim 4, further comprising:
determining a system state for the system; and
loading, based on the system state, the cooling table.

8. An apparatus comprising: a computer processor, a computer memory operatively coupled to the computer processor, the computer memory having disposed within it computer program instructions that, when executed by the computer processor, cause the apparatus to carry out the steps of:
identifying a hardware activity pattern associated with a system;
determining, based on the hardware activity pattern, one or more cooling actions; and
applying the one or more cooling actions to the system.

9. The apparatus of claim 8, wherein the hardware activity pattern is based on one or more uncore components.

10. The apparatus of claim 9, wherein the steps further comprise:
maintaining one or more counters associated with the one or more uncore components; and
wherein identifying the hardware activity pattern comprises identifying, based on the one or more counters, the hardware activity pattern.

11. The apparatus of claim 8, wherein determining the one or more cooling actions comprises determining, based on a cooling table, the one or more cooling actions.

12. The apparatus of claim 11, wherein the steps further comprise:
measuring one or more cooling characteristics of the one or more cooling actions; and
updating, based on the one or more cooling characteristics and a machine learning model, one or more parameters of the cooling table.

13. The apparatus of claim 12, further comprising determining to make the cooling table immutable.

14. The apparatus of claim 11, further comprising:
determining a system state for the system; and
loading, based on the system state, the cooling table.

15. A computer program product disposed upon a computer readable medium, the computer program product comprising computer program instructions that, when executed, cause a computer to carry out the steps of:
identifying a hardware activity pattern associated with a system;
determining, based on the hardware activity pattern, one or more cooling actions; and
applying the one or more cooling actions to the system.

16. The computer program product of claim 15, wherein the hardware activity pattern is based on one or more uncore components.

17. The computer program product of claim 16, wherein the steps further comprise:
maintaining one or more counters associated with the one or more uncore components; and
wherein identifying the hardware activity pattern comprises identifying, based on the one or more counters, the hardware activity pattern.

18. The computer program product of claim 15, wherein determining the one or more cooling actions comprises determining, based on a cooling table, the one or more cooling actions.

19. The computer program product of claim 18, wherein the steps further comprise:
measuring one or more cooling characteristics of the one or more cooling actions; and
updating, based on the one or more cooling characteristics and a machine learning model, one or more parameters of the cooling table.

20. The computer program product of claim 19, further comprising determining to make the cooling table immutable.
